(19) United States
(12) Patent Application Publication
(10) Pub. No.: US 2025/0141149 A1
(43) Pub. Date: May 1, 2025

(54) CAPACITIVE PLUG CONNECTION

(71) Applicant: Harting International Innovation AG, Biel (CH)

(72) Inventors: Till Riechmann, Stemwede (DE); Markus Friesen, Espelkamp (DE); Walter Gerstl, Breitenfurth near Vienna (AT); Jana Buschmann, Rahden (DE); Fabrizia Ghezzo, Biel (CH); Heiko MEIER, Minden (DE)

(73) Assignee: Harting International Innovation AG, Biel (CH)

(21) Appl. No.: 18/924,381

(22) Filed: Oct. 23, 2024

(30) Foreign Application Priority Data
Oct. 28, 2023 (DE) 10 2023 129 837.2
Mar. 8, 2024 (GB) 2403389.6

(51) Int. Cl. H01R 13/518; H01R 13/52; H01R 13/6581; H01R 13/7197

(52) U.S. Cl. CPC H01R 13/518; H01R 13/5205; H01R 13/7197; H01R 13/6581

(57) ABSTRACT

A capacitive plug connection has a first connector and a second connector. The first connector includes a first holding frame and a first base module, wherein the first holding frame has a first frame part and a second frame part. The first frame part and the second frame part are electrically isolated from each other by a dielectric isolation element, where a filter bridge connects the first frame part with the second frame part. Alternative or supplementary the second holding frame includes a first frame part and a second frame part, wherein the first frame part and the second frame part are electrically isolated from each other, wherein a filter bridge electrically connects the first frame part with the second frame part or the filter bridge is attached within the first frame part and is configured to connect an input port of the first connector with the second frame part.

### REFERENCE DATA

The present application claims priority from German patent application DE 10 2023 129 837.2 dated 28 Oct. 2023 and GB patent application GB2403389.6 dated 8 Mar. 2024, the contents of which are incorporated by reference in their entirety.

### TECHNICAL DOMAIN

The invention relates to a capacitive plug connection.

### RELATED ART

In the field of train traffic and automotive engineering, respectively, connectors are used for power and data transmission.

In these applications, high shield currents occur due to the use of converters or due to poor galvanic connection of component groups in state of the art plug connections.

The shield currents can be up to 50 ampere, which can damage or destroy contacts or plug connections. The resulting magnetic fields can also interfere with data transmissions.

### SHORT DISCLOSURE OF INVENTION

It is the task of the invention to prevent these shield currents to improve the state of the art.

According to the invention, this is achieved by a connector with a capacitive plug connection according to claim 1 and a system for using the capacitive plug connection according to claim 19. Advantageous embodiments can be taken from the sub-claims, for example. The content of the claims is made the content of the description by express inclusion.

A capacitive plug connection, comprising a first connector and a second connector, wherein the first connector comprises a first holding frame and a first base module. The first holding frame comprises a first frame part and a second frame part. The first connector comprises at least one filter bridge, wherein the at least one filter bridge:
a) is configured to electrically connect the first frame part with the second frame part; or
b) is attached within the first frame part and is configured to connect an input port of the first connector with the second frame part.

Alternative or supplementary the capacitive plug connection, comprising a second connector, wherein the second connector comprises a second holding frame and a second base module. The second holding frame comprises a first frame part and a second frame part. The second connector comprises at least one filter bridge, wherein the at least one filter bridge:
a) is configured to electrically connect the first frame part with the second frame part; or
b) is attached within the first frame part and is configured to connect an input port of the second connector with the second frame part.

The input port, can be an interface through which the first connector or the second connector receives signals or power. The input port can be part of the filter bridge. The input port may have at least one screw or solder or optical connection. The filter bridge may also comprise at least one output port. The output port may have at least one screw or solder or optical connection. The output port may be connected to the second frame part respectively to a first base module or a second base module attached to the second frame part of the first holding frame and/or second holding frame for signal or power transmission to a first interface of the first connector or a second interface of the second connector.

In another embodiment the first frame part and the second frame part are electrically isolated from each other by a dielectric isolation element or the second frame part consists of or comprises a dielectric plastic material.

The two frame parts can be produced by divide the first holding frame or the second holding frame into a first frame part and a second frame part for example by sawing to pieces or watercutting the first frame part and/or the second frame part. In these example the two frame parts can be joined or glued or attached together by the dielectric isolation element.

In an alternative embodiment the first frame part and the second frame part of the first connector and/or the second connector can be realized by attaching an extra component to the first holding frame or the second holding frame. So that the first holding frame or the second holding frame is the second frame part and the extra component is the first frame part which is supported by the first holding frame or the second holding frame. The first frame part can be attached to the second frame part by inserting the first frame part into at least one undercut or at least one protrusion of the second frame part. The first holding frame and the second holding frame can also have a cover which can be attached with a screw or a clip connection. The cover can clamp the first frame part to the second frame part or in other words the extra component to the first holding frame or the second holding frame.

In another embodiment a cable inlet can be attached to the first frame part. A cable inlet, also known as a cable entry or cable port, is a specific point where power cables or data cables are allowed to enter the first connector or the second connector. The purpose of a cable inlet is to provide a passageway for the cable while maintaining the integrity and safety of the device or equipment. This can include maintaining its dust and water resistance, insulating the internal components from the outside environment, or protecting them from potential physical damage.

The dielectric material can be a substance that is a poor conductor of electricity respectively of an electric current. That means that the flow of a current between opposite electric charge poles is kept to a minimum near zero or zero.

In an embodiment the first holding frame has a first galvanic insulating cover and the second holding frame has a second galvanic insulating cover, wherein the first galvanic insulating cover and/or the second galvanic insulating cover comprises an support for the filter bridge electrically connecting the first frame part with the second frame part.

The dielectric plastic materials and/or the dielectric isolation element and/or the first galvanic cover and/or the second galvanic cover can comprise or consist of:
Polyethylene (PE) or Polyvinylchloride (PVC) or Polystyrene (PS) or Polypropylene (PP) or Polytetrafluoroethylene also known as Teflon (PTFE) or Polyvinylidene Fluoride (PVDF) or Epoxy resin, also known as polyepoxide, which is a type of thermosetting polymer that is used widely across industries, including electronics, due to its excellent insulation properties. Epoxy resin also can exhibits strong adhesive properties, which means it can provide good mechanical strength in electronic devices. It can help keep components in place and resist vibrations, shocks, and impacts.

In another embodiment the filter bridge comprises a high-pass or a band-pass or a low-pass and/or a resistor or a combination thereof. This design can allow to block currents in certain frequency ranges. The positive effect is, that the current over the connectors will be reduced, especially parasitic currents which can cause interferences on a signaling line of the plug connection.

A high-pass filter allows signals with a frequency higher than a certain cutoff frequency to pass through and attenuates frequencies lower than the cutoff frequency. The basic structure of a high-pass filter can consist of a resistor and a capacitor. The input signal can be applied to the series combination of a resistor (R) and a capacitor (C). The output is taken across the resistor. The cutoff frequency (fc) can be calculated using the formula fc=1/(2πRC).

A band-pass filter allows signals within a certain frequency range to pass through, while frequencies outside this range are attenuated. It is essentially a combination of a high-pass and a low-pass filter. The band-pass filter has two cutoff frequencies, f1 and f2, and anything between these frequencies will pass.

A low-pass filter allows signals with a frequency lower than a certain cutoff frequency to pass through and attenuates frequencies higher than the cutoff frequency. The basic structure of a low-pass filter can also consist of a resistor and a capacitor. However, in this case, the input signal is applied to the series combination of a resistor (R) and a capacitor (C), but the output is taken across the capacitor. The cutoff frequency (fc) can be calculated using the formula fc=1/(2πRC).

In another embodiment the filter bridge comprises at least two spring contacts. The spring contacts can be used to electrically connect the first frame part with the second frame part. Another possibility for connecting the frame parts can be a solder connection and/or a screw connection with the filter bride.

The filter bridge can be attached to the first frame part or the filter bridge can be integrally integrated with the frame part. In an embodiment two opposite inner sides of the first frame part can be metalized and the electronic components can be electrically connected to these sides to establish a desired electronic circuit.

The first frame part or the filter bridge can be a Molded Interconnect Device (MID). MIDs can be three-dimensional electro-mechanical devices that incorporate an electrical circuit or circuits. This technology allows for the integration of mechanical and electronic functions into a single device, thereby simplifying complex electronic systems. The MID technology integrates circuitry directly onto plastic housings, allowing the creation of highly reliable, resilient, compact devices and connectors.

Structurally, an MID can be like a PCB but can be in 3D and can comprise at least one of the following major elements. It also can be a multilayer board: The substrate or base structure of an MID can typically a high-temperature, thermoplastic polymer or a class of printed circuit board base material for example FR4. This serves as the mechanical support structure for the device. The plastic material is chosen such that it can withstand the temperatures of downstream process steps, like metallization.

One example for a high-temperature, thermoplastic polymer is PEEK. Polyether ether ketone, or PEEK. PEEK is a semi-crystalline thermoplastic with excellent mechanical and chemical resistance properties, even at very high temperatures (up to 250 C continuously and peaks up to 300 C). It is highly resistant to thermal degradation, as well as attack by both organic and aqueous environments.

The heart of an MID can be its conductive circuitry. This can laid on top of the substrate, and can be produced by several methods. One common technique can be Laser Direct Structuring (LDS), where a laser activates the areas of the plastic for subsequent electroless copper plating. Other methods can include two-shot injection molding and/or hot stamping.

Once the conductive circuitry is in place, at least one electronic components like sensors and/or switches and/or capacitors and/or resistors and/or connectors and/or inductivities can be added as required.

Finally, a protective coating can be applied over the conductive circuitry to protect it from environmental factors and damage.

The MID can comprise at least one input port and at least one output port. Each of these ports can have several contacts for connecting an electric or optical signal and/or a power supply to the first connector or the second connector.

In an embodiment the capacitive plug connection comprises a first connector and a second connector, wherein the first base module is attached within the first holding frame, wherein the first holding frame comprises a first end and a second end opposing to the first end, wherein the second end has the first interface for data and/or power transmission and/or reception, wherein the second base module is attached within the second holding frame, wherein the second holding frame comprises a first end and a second end opposing to the first end, wherein the second end has the second interface for data and/or power transmission and/or reception.

In an embodiment the first base module and the second base module can comprise or consists of the electrical parts for the data transmission and/or reception. Each of the base modules can therefore comprise contacts. These contacts are the metal parts that carry an electrical signal from the first connector or the second connector to another. They are configured to make a reliable electrical connection while also being easy to connect and disconnect. The design of the contacts within the first base module and/or the second base model can depend on the type of connector. The contacts can be pins or sockets or blades. The design ensures that a secure electrical connection is made when the connector is plugged in.

In another embodiment the first connector or the second connector can comprise spring contacts to connect the first holding frame to the second holding frame in a mated state of the first connector and the second connector.

In a preferred embodiment the first interface can be configured as circumferential inner surface of the second holding frame. In other words, the circumferential line in radial direction. In the context of the capacitive plug connection, radial shall be understood as from inside of the first connector or the second connector to outside orthogonal to a common axis from the first end to the second end of the first connector or the second connector or parallel thereto.

In a preferred embodiment the first connection area has at the second end of the first holding frame a different diameter then the first end of the first holding frame. The second connection area has at the second end of the second holding frame an opening configured to receive the first connection area of the first holding frame. The first galvanic insulating layer is located between the first holding frame and the second holding frame. Respectively the first galvanic insulating layer can be located between the outer and the inner surfaces of the connection areas in a mated state. Therefore, the first holding frame can be insulated from the second holding frame.

In an embodiment the opening at the second end of the second holding frame is arranged rectangular to the second connection area. The opening can pointing inwardly into the second holding frame for the second connector. The opening can pointing from the second end towards the first end.

In a preferred embodiment the second connection area can be configured as circumferential inner surface of the opening at the second end of the second holding frame. In other words, the circumferential line of the second connection area in radial direction.

In an embodiment the first base module with the first interface and the second base module with the second interface are configured to establish a data transmission line. The data transmission line is a contacting transmission line or a capacitive transmission line or an inductive transmission line or an optical transmission line.

In a preferred embodiment the contacting transmission line comprises spring contacts, wherein the first interface is configured as plug or socket or the second interface is configured as socket or as plug.

In another preferred embodiment the first base module with the first interface and the second base module with the second interface can comprise an galvanic data transmission line and/or a capacitive data transmission line and/or a galvanic data transmission line and/or an optic data transmission line.

In an embodiment the first holding frame and the second holding frame comprises metal or consists of metal.

In another embodiment the first interface and the second interface has a rectangular or a cylindrical shape from plan view.

In an embodiment the first base module and the second base module are configured to transmit data and/or power between the first connector and the second connector and/or the second connector and the first connector.

In another embodiment the second end has a first connection area at the first interface. The second connector comprises a second holding frame and a second base module, wherein the second base module is arranged in the second holding frame. The second end has a second connection area at the second interface. A first galvanic insulating layer is attached between the first connection area of the first holding frame and the second connection area of the second holding frame. The first interface and/or the second interface can be configured to transmit power and/or data.

In another preferred embodiment, the first connection area can comprise a first end pointing towards the first end of the first holding frame and second end opposing to the first end pointing towards the second end of the first holding frame.

In a preferred embodiment the first connection area can be configured as a circumferential outer surface of the first holding frame. In other words, the circumferential line of the first connection area in radial direction.

In another preferred embodiment, the second connection area can comprise a first end pointing towards the first end of the second holding frame and second end opposing to the first end pointing towards the second end of the second holding frame.

In a preferred embodiment the first connection area can be configured as circumferential inner surface of the second holding frame. In other words, the circumferential line in radial direction. In the context of the capacitive plug connection, radial shall be understood as from inside of the first connector or the second connector to outside orthogonal to a common axis from the first end to the second end of the first connector or the second connector or parallel thereto.

In an embodiment the opening at the second end of the second holding frame is arranged rectangular to the second connection area. The opening can pointing inwardly into the second holding frame for the second connector. The opening can point from the second end towards the first end.

In a preferred embodiment the second connection area can be configured as circumferential inner surface of the opening at the second end of the second holding frame. In other words, the circumferential line of the second connection area in radial direction.

In a preferred embodiment the first connection area has at the second end of the first holding frame a different diameter then the first end of the first holding frame. The second connection area has at the second end of the second holding frame an opening configured to receive the first connection area of the first holding frame. The first galvanic insulating layer is located between the first holding frame and the second holding frame. Respectively the first galvanic insulating layer can be located between the outer and the inner surfaces of the connection areas in a mated state. The mated state of the capacitive plug connection refers to when the capacitive plug connection (male end, plug) is properly inserted and connected to its corresponding outlet or socket (female end). In this state, the connection is secure, intact, and electrical signals can be transmitted between the first connector and the second connector.

In another embodiment the first galvanic insulating layer comprises Aluminum Oxide (Al2O3) or Silicon Oxide (SiOx), such as Silicon Dioxide or consists of Al2O3 or SiOx.

In an embodiment the first galvanic insulating layer is a Physical Vapor Deposition (PVD) or Chemical Vapor Deposition (CVD) coated part.

In another embodiment the first galvanic insulating layer is a Polyimide (PI) or Polytetrafluoroethylene (PTFE) coated part.

In an embodiment the first galvanic insulating layer has a thickness between 5 μm and 20 μm.

The invention also discloses a system comprising the aforementioned capacitive plug connection.

In an embodiment a system for using a capacitive plug connection comprises a grommet housing or an add-on housing are accommodating the first connector and wherein, a grommet housing or an add-on housing are accommodating the second connector.

In a preferred embodiment the first galvanic insulating cover is configured to insulate the first connector from the grommet housing or the add-on housing and the second galvanic insulating cover is configured to insulate the second connector from the grommet housing or the add-on housing.

In another preferred embodiment the grommet housing or the add-on housing accommodating the first connector and the add-on housing or the grommet housing accommodating the second connector are connectable with a screw connection or a snap connection to establish a power and/or data transmission line.

In another embodiment the add-on housing can be attached to a control cabinet or to an electric sub distribution. The grommet housing can be a type of prefabricated housing or module that is designed to fit around electrical plugs or outlets. These modules can be made of lightweight materials such as steel or aluminum frames and are intended to be easy to install and reconfigure as needed and can be attached to the add-on housing.

In another preferred embodiment an intermediate frame is needed to accommodate the first connector to the add-on housing or the grommet housing and/or the second connector to the add-on housing or the grommet housing. The intermediate frame for the first connector or the second connector can be configured as a one piece intermediate frame or a divisible intermediate frame. The divisible intermediate frame can comprise a first half shell and a second half shell. The divisible intermediate frame can comprise at least one screw connection for connecting the first half shell and the second half shell.

The invention is not limited to the described embodiments. Within the scope of the invention, all described and/or drawn features can be combined with each other as desired, unless otherwise indicated.

### SHORT DESCRIPTION OF THE DRAWINGS

An embodiment of the invention is shown in the drawing and is explained in more detail below. It is shown in:

FIG. 1 a capacitive plug connection according to an embodiment of the invention with a dielectric isolation element; and

FIG. 2 a capacitive plug connection according to an embodiment of the invention in a sectional view with a dielectric isolation element; and

FIG. 3 a capacitive plug connection according to an embodiment of the invention in a sectional view with a dielectric isolation element; and

FIG. 4 a capacitive plug connection as an insert for a grommet housing and an add-on housing; a

FIG. 5 a capacitive plug connection according to an embodiment of the invention in sectional with two frame parts; and

FIG. 6 a capacitive plug connection according to an embodiment of the invention in with two frame parts

FIG. 7 a capacitive plug connection according to an embodiment of the invention in sectional with two frame parts

FIG. 8 a capacitive plug connection according to an embodiment of the invention; and

FIG. 9 a capacitive plug connection according to an embodiment of the invention in a sectional view.

### EXAMPLES OF EMBODIMENTS OF THE PRESENT INVENTION

Some of the figures contain simplified, schematic representations. In some cases, identical reference signs are used for the same, but possibly not identical, elements. Different views of the same elements might be scaled differently. Directions such as “left”, “right”, “up” and “down” are to be understood in relation to the respective figure and may vary in the individual representations compared to the object depicted.

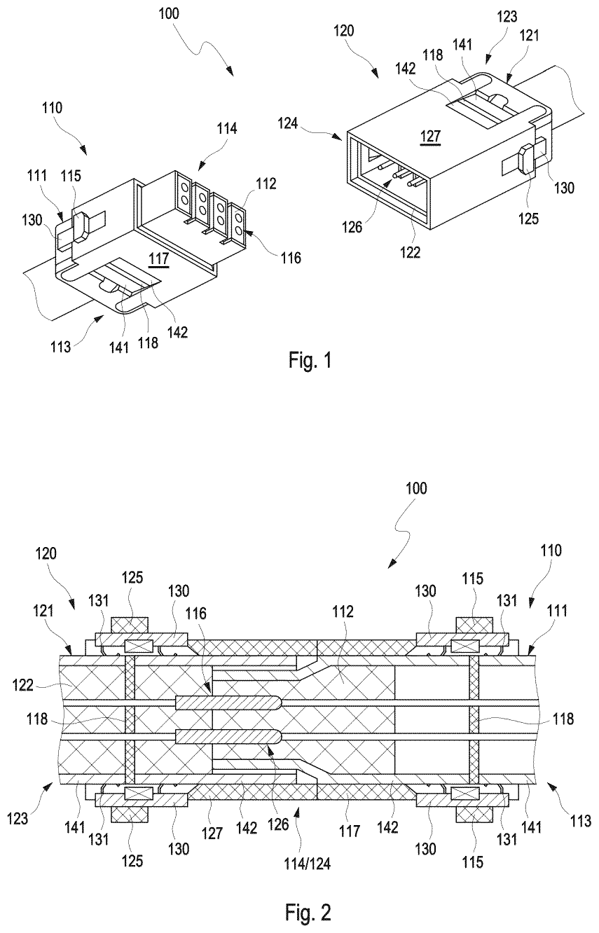

FIG. 1 discloses a capacitive plug connection 100 with a first connector 110 and a second connector 120. The first connector 110 comprises a first fist holding frame 111 and a first base module 112, wherein the first base module 112 is attached within the first holding frame 111. The first holding frame 111 comprises a first end 113 and a second end 114 opposing to the first end 113. The second end 114 has a first interface 116 for data transmission.

The second connector 120 comprises a second holding frame 121 and a second base module 122, wherein the second base module 122 is arranged in the second holding frame 121. The second holding frame 121 comprises a first end 123 and a second end 124 opposing to the first end 123. The second end 124 has a second interface 126 for data transmission.

The first holding frame 111 and the second holding frame 121 comprises a first frame 141 part and a second frame 142 part, wherein the first frame part 141 and the second frame part 142 of the first holding frame 111 and the second holding frame 121 are electrically isolated from each other by a dielectric isolation element 118, wherein a filter bridge 130 connects the first frame part 141 with the second frame part 142.

The first holding frame 111 and the second holding frame 121 has a first and a second galvanic insulating cover 117, 127.

The first galvanic insulating cover 117 and the second galvanic insulating cover 127 comprises an support 115, 125 for the at least one filter bridge 130 electrically connecting the first frame part 141 with the second frame part 142.

FIG. 2 discloses a capacitive plug connection 100 in an sectional view with a first connector 110 and a second connector 120 in a mated state.

The first connector 110 comprises a first fist holding frame 111 and a first base module 112, wherein the first base module 112 is attached within the first holding frame 111. The first holding frame 111 comprises a first end 113 and a second end 114 opposing to the first end 113. The second end 114 has a first interface 116 for data transmission.

The second connector 120 comprises a second holding frame 121 and a second base module 122, wherein the second base module 122 is arranged in the second holding frame 121. The second holding frame 121 comprises a first end 123 and a second end 124 opposing to the first end 123. The second end 124 has a second interface 126 for data transmission.

The first holding frame 111 and the second holding frame 121 has a first and a second galvanic insulating layer 117, 127 covering the first connector 110 and the second connector 120.

The first holding frame 111 and the second holding frame 121 comprises a first frame 141 part and a second frame 142 part, wherein the first frame part 141 and the second frame part 142 of the second holding frame 121 are electrically isolated from each other by a dielectric isolation element 118, wherein a filter bridge 130 connects the first frame part 141 with the second frame part 142.

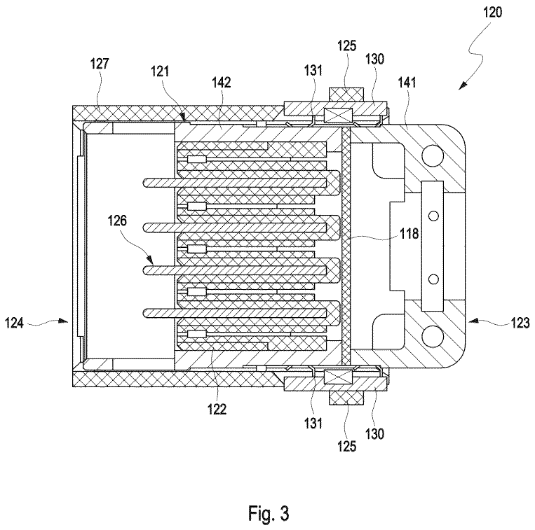

FIG. 3 discloses a sectional drawing of the second connector 120. The second connector 120 comprises a first holding frame 121 and a first base module 122, wherein the first holding frame 111 comprises a first frame part 141 and a second frame part 142. The first frame part 141 and the second frame part 142 are electrically isolated from each other by a dielectric isolation element 118, where a filter bridge 118 electrically connects the first frame part 141 with the second frame part 142.

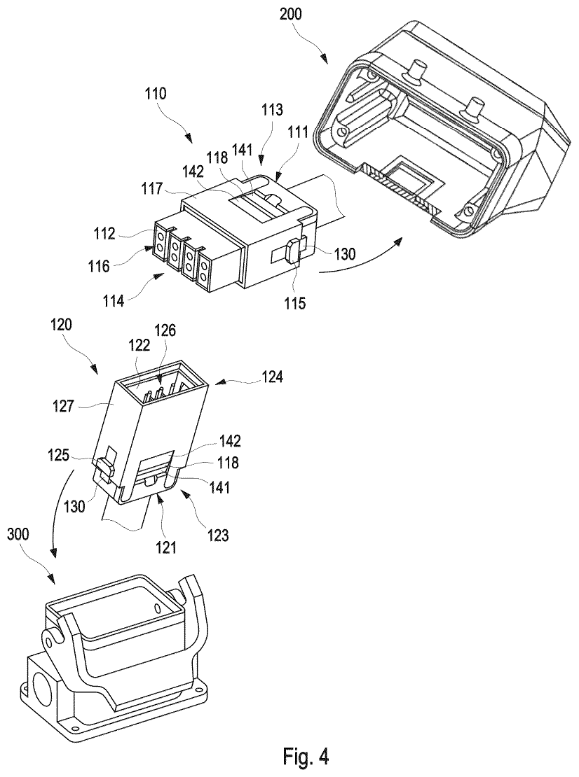

FIG. 4 discloses a capacitive plug connection 100 with a first connector 110 and a second connector 120. The first connector 110 is located in a grommet housing 200 and the second connector is located in an add-on housing 300. The first and the galvanic insulating cover 117, 127 insulates the first connector 110 from the grommet housing 200 and the second connector 120 from the add-on housing 300.

For attaching the first connector 110 to the grommet housing 200 and the second connector 120 to the add-housing 300 a not shown intermediate frame is used. The intermediate frame for the first connector 110 or the second connector 120 is configured as a divisible intermediate frame. The divisible intermediate frame comprises a first half shell and a second half shell. The divisible intermediate comprises not shown two screw connection for connecting the first half shell and the second half shell of the intermediate frame.

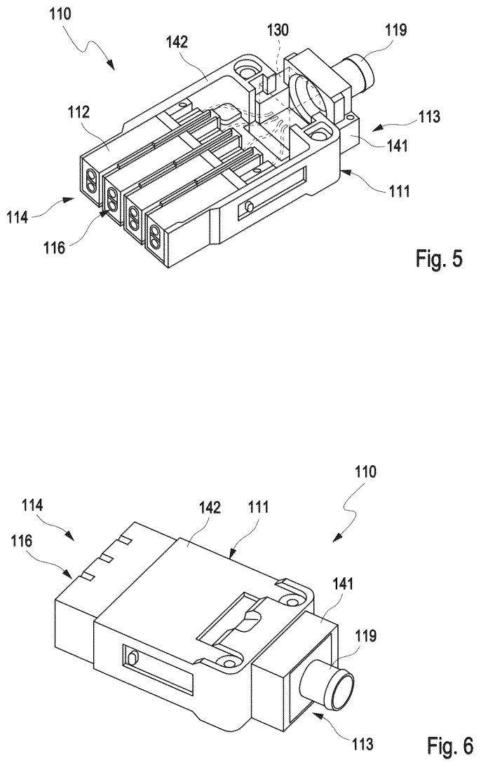

FIG. 5 discloses a capacitive plug connection 100 in a sectional view with a first connector 110. The first connector 110 comprises a first fist holding frame 111 and a first base module 112, wherein the first base module 112 is attached within the first holding frame 111. The first holding frame 111 comprises a first end 113 and a second end 114 opposing to the first end 113. The second end 114 has a first interface 116 for data transmission.

The first holding frame 111 and the second holding frame 121 comprises a first frame part 141 and a second frame 142 part, wherein the first frame part 141 and the second frame part 142 of the second holding frame 121 are electrically isolated from each other. Wherein the first frame part 141 consists of or comprises of a dielectric plastic material. A cable inlet 119 is attached to the second frame part 142. The second frame part 142 is attached to the first frame part 141 by inserting the first frame 141 part into two undercuts of the second frame part 142. A filter bride 130 is attached to or in other words within the first frame part 141 and is configured to connect an input port 128, which is not shown of the first connector 120 respectively the filter bridge 130 to the second frame part 142. The input port 128, can be used to connect a cable to the filter bridge 130. The filter bridge 130 has two output ports 129, which are not shown, where the first base module 112 respectively the first interface 116 is connected thereto. The second frame part 142 is attached to the first frame part 141 by inserting the first frame 141 part into two undercuts of the second frame part 142.

FIG. 6 discloses a capacitive plug connection 100 with a first connector 110. The first connector 110 comprises a first fist holding frame 111 and a first base module 112, wherein the first base module 112 is attached within the first holding frame 111. The first holding frame 111 comprises a first end 113 and a second end 114 opposing to the first end 113. The second end 114 has a first interface 116 for data transmission.

The first holding frame 111 and the second holding frame 121 comprises a first frame part 141 and a second frame 142 part, wherein the first frame part 141 and the second frame part 142 of the second holding frame 121 are electrically isolated from each other. Wherein the first frame part 141 consists of or comprises of a dielectric plastic material. A cable inlet 119 is attached to the second frame part 142.

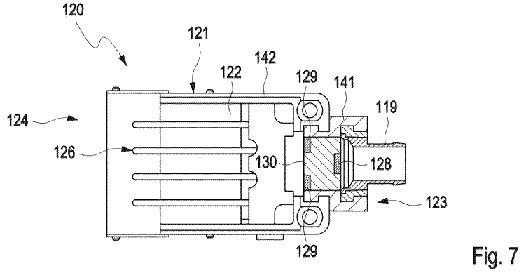

FIG. 7 discloses with a second connector 120. The second connector 120 comprises a first fist holding frame 121 and a second base module 122, wherein the second base module 122 is attached within the first holding frame 121. The first holding frame 121 comprises a first end 123 and a second end 124 opposing to the first end 123. The second end 124 has a second interface 126 for data and/or power transmission.

The second holding frame 121 comprises a first frame part 141 and a second frame 142 part of the second holding frame 121 are electrically isolated from each other. Wherein the first frame part 141 consists of or comprises of a dielectric plastic material. A cable inlet 119 is attached to the second frame part 142. A filter bride 130 is attached to or in other words within the first frame part 141 and is configured to connect an input port 128 of the second connector respectively the filter bridge 130 to the second frame part 142. The input port 128, can be used to connect a cable to the filter bridge 130. The filter bridge 130 has two output ports 129 where the second base module 122 respectively the second interface 126 is connected thereto. The second frame part 142 is attached to the first frame part 141 by inserting the first frame 141 part into two undercuts of the second frame part 142.

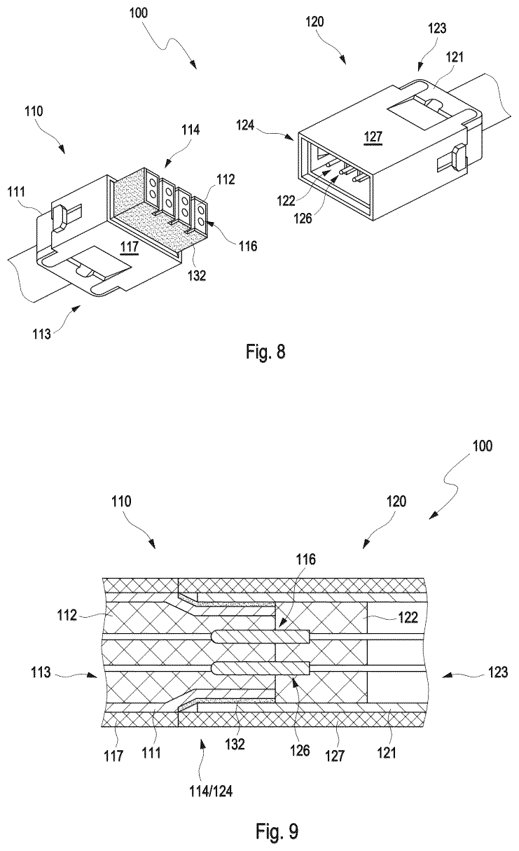

FIG. 8 discloses a capacitive plug connection 100 with a first connector 110 and a second connector 120. The first connector 110 comprises a first fist holding frame 111 and a first base module 112, wherein the first base module 112 is attached within the first holding frame 111. The first holding frame 111 comprises a first end 113 and a second end 114 opposing to the first end 113. The second end 114 has a first connection area with a first interface 116 for data transmission.

The second connector 120 comprises a second holding frame 121 and a second base module 122, wherein the second base module 122 is arranged in the second holding frame 121. The second holding frame 121 comprises a first end 123 and a second end 124 opposing to the first end 123. The second end 124 has a second connection area with an second interface 126 for data transmission.

A first galvanic insulating layer 132 is attached between the first connection area of the first holding frame 111 and the second connection area of the second holding frame 121. The position of the first galvanic insulating layer 132 is given in the mated state of the capacitive plug connection 100 between the first connector 110 and the second connector 120. The connection are 115 is covered with the first galvanic insulating layer.

The first holding frame 111 and the second holding frame 121 has a first galvanic insulation cover 117 for the first holding frame 111 and a second galvanic insulating cover 127 for the second holding frame 121. The galvanic insulating layer 132 between the first holding frame 111 and the second holding frame 121 respectively the galvanic insulating layer on the connection are of the first holding frame 111 is uncovered by the first galvanic insulating cover 118 of the first holding frame 111.

FIG. 9 discloses a capacitive plug connection 100 in an sectional view with a first connector 110 and a second connector 120 in a mated state.

The first connector 110 comprises a first fist holding frame 111 and a first base module 112, wherein the first base module 112 is attached within the first holding frame 111. The first holding frame 111 comprises a first end 113 and a second end 114 opposing to the first end 113. The second end 114 has a first connection area with a first interface 116 for data transmission.

The second connector 120 comprises a second holding frame 121 and a second base module 122, wherein the second base module 122 is arranged in the second holding frame 121. The second holding frame 121 comprises a first end 123 and a second end 124 opposing to the first end 123. The second end 124 has a second connection area with an second interface 126 for data transmission.

A galvanic insulating layer 132 is attached between the first connection area of the first holding frame 111 and the second connection area of the second holding frame 121. The position of the galvanic insulating layer 132 is given in the mated state of the capacitive plug connection 100 between the first connector 110 and the second connector 120.

The first holding frame 111 and the second holding frame 121 has a first and a second galvanic insulating cover 117, 127 covering the first connector 110 and the second connector 120. The first connection area is not covered from the galvanic insulating cover. The first connection area is covered by the galvanic insulating layer 132 preventing an electrical contact between the first connector 110 and the second connector 120 respectively the first connection area and the second connection area.

REFERENCE SYMBOLS IN THE FIGURES

| | |
|---|---|
| Capacitive plug connection | 100 |
| First connector | 110 |
| First holding frame | 111 |
| First base module | 112 |
| First end | 113 |
| Second end | 114 |
| First Support | 115 |
| First interface | 116 |
| First galvanic insulating cover | 117 |
| Dielectric isolation element | 118 |
| Cable inlet | 119 |
| Second connector | 120 |
| Second holding frame | 121 |
| Second base module | 122 |
| First end | 123 |
| Second end | 124 |
| Second Support | 125 |
| Second interface | 126 |
| Second galvanic insulating cover | 127 |
| Input port | 128 |
| Output port | 129 |
| Filter Bridge | 130 |
| Spring contact | 131 |
| Galvanic insulation layer | 132 |
| First frame part | 141 |
| Second frame part | 142 |
| Grommet housing | 200 |
| Add-on housing | 300 |

1. A capacitive plug connection, comprising,
a first connector and a second connector, wherein,
the first connector comprises a first holding frame and a first base module, wherein
the first holding frame comprises a first frame part and a second frame part,
the first connector comprises at least one filter bridge, wherein the at least one filter bridge:
a) is configured to electrically connect the first frame part with the second frame part; or
b) is attached within the first frame part and is configured to connect an input port of the first connector with the second frame part and/or
the second connector comprises a second holding frame and a second base module,
wherein the second holding frame comprises a first frame part and a second frame part,
the second connector comprises at least one filter bridge, wherein the at least one filter bridge:
a) is configured to electrically connect the first frame part with the second frame part; or
b) is attached within the first frame part and is configured to connect an input port of the second connector with the second frame part.

2. The capacitive plug connection, according to claim 1,
wherein the first frame part and the second frame part are electrically isolated from each other by a dielectric isolation element or the second frame part consists of or comprises a dielectric plastic material.

3. The capacitive plug connection, according to claim 1,
wherein the first holding frame has a first galvanic insulating cover and the second holding frame has a second galvanic insulating cover, wherein
the first galvanic insulating cover and/or the second galvanic insulating cover comprises a support for the at least one filter bridge electrically connecting the first frame part with the second frame part.

4. A capacitive plug connection according to claim 1, wherein the filter bridge comprises a high-pass or a band-pass or a low-pass and/or a resistor.

5. A capacitive plug connection according to claim 1, wherein the filter bridge comprises at least two spring contacts for electrically connecting the first frame part to the second frame part.

6. A capacitive plug connection according to claim 1, wherein the first base module is attached within the first holding frame, wherein
the first holding frame comprises a first end and a second end opposing to the first end, wherein
the second end has a first interface for data transmission and/or reception, and/or,
the second base module is attached within the second holding frame, wherein
the second holding frame comprises a first end and a second end opposing to the first end,
wherein
the second end has a second interface for data transmission and/or reception.

7. The capacitive plug connection according to claim 1, wherein the first base module with the first interface and the second base module with the second interface are configured to establish a data transmission line, wherein
the data transmission line is a contacting transmission line or a capacitive transmission line or an inductive transmission line or an optical transmission line.

8. The capacitive plug connection according to claim 7, wherein the contacting transmission line comprises spring contacts, wherein the first interface is configured as a plug or a socket or the second interface is configured as a socket or as a plug.

9. The capacitive plug connection according to claim 1, the first holding frame and the second holding frame comprises metal or consists of metal.

10. The capacitive plug connection according to claim 6, wherein the first interface and the second interface has a rectangular or a cylindrical shape from plan view.

11. The capacitive plug connection according to claim 1, wherein the first base module and the second base module are configured to transmit data and/or power between the first connector and the second connector and/or the second connector and the first connector.

12. The capacitive plug connection according to claim 6, wherein the second end has a first connection area at the first interface, wherein
the second connector comprises a second holding frame and a second base module, wherein
the second base module is arranged in the second holding frame, wherein
the second end has a second connection area at the second interface, wherein
a galvanic insulating layer is attached between the first connection area of the first holding frame and the second connection area of the second holding frame.

13. The capacitive plug connection according to claim 12,
wherein the first connection area has at the second end of the first holding frame a different diameter then the first end of the first holding frame, wherein
the second connection area has at the second end of the second holding frame an opening configured to receive the first connection area of the first holding frame, wherein
the galvanic insulating layer is located between the first holding frame and the second holding frame.

14. The capacitive plug connection according to claim 12, wherein the galvanic insulating layer comprises Al2O3 or SiOx or consists of Al2O3 or SiOx.

15. The capacitive plug connection according to claim 12, wherein the galvanic insulating layer is a PVD or CVD coated part.

16. The capacitive plug connection according to claim 12, wherein the galvanic insulating layer is a PI or PTFE coated part.

17. The capacitive plug connection according to claim 12, wherein the galvanic insulating layer has a thickness between 5 μm and 20 μm.

18. The capacitive plug connection according to claim 12, wherein the galvanic insulating layer between the first holding frame and the second holding frame is uncovered by the first galvanic insulating cover of the first holding frame.

19. A System according comprising a capacitive plug connection according to claim 1, wherein a grommet housing or an add-on housing are accommodating the first connector and a grommet housing or an add-on housing are accommodating the second connector.

20. The system according to claim 19, wherein the first galvanic insulating cover is configured to insulate the first connector from the grommet housing or the add-on housing and the second galvanic insulating cover is configured to insulate the second connector from the grommet housing or the add-on housing.

21. The system according to claim 19, wherein the grommet housing or the add-on housing accommodating the first connector and the add-on housing or the grommet housing accommodating the second connector are connectable with a screw connection or a snap connection to establish a data transmission line.
